(19) United States
(12) Patent Application Publication
(10) Pub. No.: US 2025/0369581 A1
(43) Pub. Date: Dec. 4, 2025

(54) LIGHT PROJECTION SYSTEM

(71) Applicant: Texas Instruments Incorporated, Dallas, TX (US)

(72) Inventors: Gavin Perrella, Dallas, TX (US); Alexander Lyubarsky, Dallas, TX (US); Samuel Martin, Dallas, TX (US); Jorge Gonzalez Maciel, McKinney, TX (US)

(21) Appl. No.: 19/042,146

(22) Filed: Jan. 31, 2025

Related U.S. Application Data
(60) Provisional application No. 63/655,424, filed on Jun. 3, 2024.

(51) Int. Cl. F21S 41/176; F21S 41/27; F21S 41/32; F21S 41/64

(52) U.S. Cl. CPC F21S 41/176; F21S 41/27; F21S 41/32; F21S 41/645

(57) ABSTRACT

Light projectors, examples of which may be used in headlight assemblies and/or other display applications. In one example, a system includes a phase light modulator, a phosphor device optically coupled to the phase light modulator, and a spatial light modulator optically coupled the phosphor device.

### CROSS-REFERENCE TO RELATED APPLICATIONS

This application claims the benefit of and priority to U.S. Provisional Patent Application No. 63/655,424 titled “FULL FIELD OF VIEW HIGH RESOLUTION ADAPTIVE HEADLIGHT USING A PHASE LIGHT MODULATOR IN COMBINATION WITH A SPATIAL LIGHT MODULATOR” and filed on Jun. 3, 2024, which Application is hereby incorporated herein by reference in its entirety.

### TECHNICAL FIELD

This description relates to light projectors, and more particularly, to light projection systems that can be used in headlight assemblies.

### BACKGROUND

Modern headlights can cover wide fields of view to illuminate a relatively large area in front of the vehicle. The output profile (e.g., shape, brightness distribution, and/or other characteristics of the beam) of traditional headlights is mostly static. Furthermore, traditional headlights have non-uniform output profiles. For example, the headlight beam may have a very high peak intensity (high brightness) near the center of the field of view, to allow the driver to see far distances, with a steep drop-off to lower intensities near the edges of the field of view.

### SUMMARY

According to one example, a system comprises a phase light modulator, a phosphor device optically coupled to the phase light modulator, and a spatial light modulator optically coupled to the phosphor device.

According to another example, a headlight assembly comprises a light projector including a phosphor device comprising a phosphor, a phase light modulator arranged to illuminate the phosphor device with a modulated source beam to stimulate the phosphor to produce an emission, and a spatial light modulator arranged to receive the illumination beam from the phosphor device and configured to project a headlight beam based on the illumination beam, wherein the illumination beam comprises the emission from the phosphor and at least a portion of the modulated source beam.

According to another example, a vehicle comprises a headlight assembly including a light projector. The light projector may comprise a light source configured to emit a source beam, a phase light modulator configured to modulate the source beam according to a computer generated hologram to produce a modulated source beam, a phosphor device configured to provide an illumination beam responsive to the modulated source beam, and a spatial light modulator configured to project a headlight beam having a profile based on the illumination beam from the phosphor device. The headlight assembly may further include a control system coupled to the light projector and configured to control the light projector to shape a profile of the headlight beam. The vehicle may further comprise at least one sensor coupled to the control system, wherein the control system is configured to control the light projector, based on a signal from the at least one sensor, to adjust one or more characteristics of the headlight beam.

### BRIEF DESCRIPTION OF THE DRAWINGS

FIG. 1 is a diagram of a vehicle including a light projection system, according to an example.

FIG. 2 is a block diagram illustrating a light projection system, according to an example.

FIG. 3A is a block diagram illustrating the light projection system of FIG. 2, according to an example.

FIG. 3B is a block diagram illustrating the light projection system of FIG. 2, according to another example.

FIG. 3C is a block diagram illustrating the light projection system of FIG. 2, according to another example.

FIG. 4 is a diagram illustrating phase separation between two light beams, according to an example.

FIG. 5 is a block diagram of an optical system forming part of a light projection system, according to an example.

FIG. 6A is a diagram illustrating a side view of an optical arrangement for the optical system of FIG. 5, according to an example.

FIG. 6B is a diagram illustrating a perspective view of the optical arrangement of FIG. 6A, according to an example.

FIG. 6C is a diagram illustrating another perspective view of the optical arrangement of FIGS. 6A and 6B, according to an example.

FIG. 7 is a diagram illustrating an optical arrangement for the optical system of FIG. 5, according to another example.

FIG. 8A is a diagram illustrating an optical arrangement for the optical system of FIG. 5, according to another example.

FIG. 8B is a diagram illustrating an optical arrangement for the optical system of FIG. 5, according to another example.

FIG. 9 is a diagram illustrating an optical arrangement for the optical system of FIG. 5, according to another example.

### DETAILED DESCRIPTION

Techniques are described herein for producing a light beam with an adaptive profile. As used herein, the term profile refers to a spatial variation in, or distribution of, the brightness of light over the field of view covered by the light. In some examples, techniques described herein can be used in automotive headlight assemblies to provide a full field of view, high-resolution, adaptive headlight beam. Other platform or applications may also benefit from the techniques (e.g., head-worn light assemblies, aerial platform light assemblies, drone platform light assemblies, to name a few examples. In any such examples, a phase light modulator may be used in combination with a spatial light modulator in a single projection path. Such a combination provides the ability to reallocate output light across the full field of view into an arbitrary profile so as to provide spatial variance of light intensity, and with relatively high-resolution control.

According to certain examples, a light projector comprises a phase light modulator, a phosphor device optically coupled to the phase light modulator, and a spatial light modulator optically coupled the phosphor device, wherein the phosphor device is positioned in an optical path between the phase light modulator and the spatial light modulator. The phase light modulator can be configured to modulate an incident source beam from the light source to produce a modulated source beam. The phosphor device can be arranged to receive the modulated source beam and includes a phosphor that produces an emission based on the modulated source beam. The spatial light modulator can be arranged to receive an illumination beam from the phosphor device, the illumination beam comprising the emission from the phosphor and at least a portion of the modulated source beam that is either reflected or transmitted by the phosphor device towards the spatial light modulator. The spatial light modulator is configured to project a light beam having a profile based on the illumination beam from the phosphor device. In some examples, the light projector is included in a headlight assembly for a vehicle, and the projected light beam can be a headlight beam. The light projector can be configured to control the profile of the headlight beam to provide various characteristics and/or functionality associated with the headlight beam.

These and other features are described in more detail below.

### General Overview

It can be desirable to provide headlight beams for cars and other vehicles and platforms that have characteristics that can assist the driver and/or platform mission. For example, providing headlight beams with a wide field of view (e.g., approximately 70×15 degrees) can illuminate not only the path directly in front of the vehicle, but also to the sides, allowing the driver to see potential hazards or information (e.g., signs etc.) that may be alongside the roadway. As described above, modern headlights often have a non-uniform output profile to provide high brightness near the center of the field of view to allow the driver to see far distances. However, for some headlight assemblies, the output profile is mostly static. In contrast, it can be desirable to adjust the projected light profile as the car travels to provide an adaptive driving beam (ADB) and optionally also the ability to project symbols or other information within the beam. For example, it can be desirable to adaptively dim regions of the headlight beams seen by oncoming traffic, shift the projected profile during turns or when traveling up and down hills, and/or project symbols near the vehicle to inform the driver of changing conditions or to communicate with pedestrians. However, headlights with static output profiles, or low resolution control over the output profile, are unable to perform these functions that could improve the driving experience and safety of drivers and pedestrians. A spatial light modulator, such as a digital micromirror device (DMD) or liquid crystal display device, can be used to provide some control over a portion of the projected light profile. However, it can be challenging and/or power inefficient to create a highly non-uniform output profile using only a spatial light modulator. Furthermore, factors such as the array shape and/or etendue of the spatial light modulator may limit the field of view and/or peak brightness of the projected light beam. A spatial light modulator module can be used to supplement other projection modules such that the combination of multiple modules produce a headlight beam having desired characteristics. However, the use of multiple modules each producing a respective output beam, and some or all of which may need to be mounted on mechanically movable platforms, creates alignment challenges and other complexities.

Accordingly, techniques are disclosed herein for providing a headlight solution that is capable of producing a high brightness beam with an adaptive, non-uniform profile using a single optical projection module. According to certain examples, an automotive headlight assembly (or other light projection system) comprises a combination of a phase light modulator and a spatial light modulator that operate together, in a single projection path, to provide a projected beam that is precisely and dynamically controllable. With the phase light modulator, the output profile of the projected beam can be dynamically and arbitrarily shifted over the full field of view, without the need for mechanical swivels, while the spatial light modulator may provide high resolution control to perform precise adaptive driving beam functions and symbol projection across the full field of view. As described in more detail below, according to certain examples, a light projection system uses a laser light source, or other coherent light source, to illuminate a phase light modulator, which modulates the incident beam according to a computer generated hologram to form an image onto a phosphor. The phosphor emission, along with at least a portion of modulated light beam from the phase light modulator (e.g., transmitted through or reflected by the phosphor device), forms an illumination beam that can be imaged onto the spatial light modulator. In turn, the spatial light modulator projects the beam onto a display surface, such as a roadway or other surface. The illumination beam imaged to the spatial light modulator can be a white light beam (produced from a combination of the light from the light source and the emission from the phosphor) that carries a profile shape for the projected beam encoded by the phase light modulator. Such a light projection system may replace the multiple modules used in other headlight assemblies, thus alleviating the alignment issues described above, while also providing enhanced performance in a more compact, integrated package.

### Example System Architecture

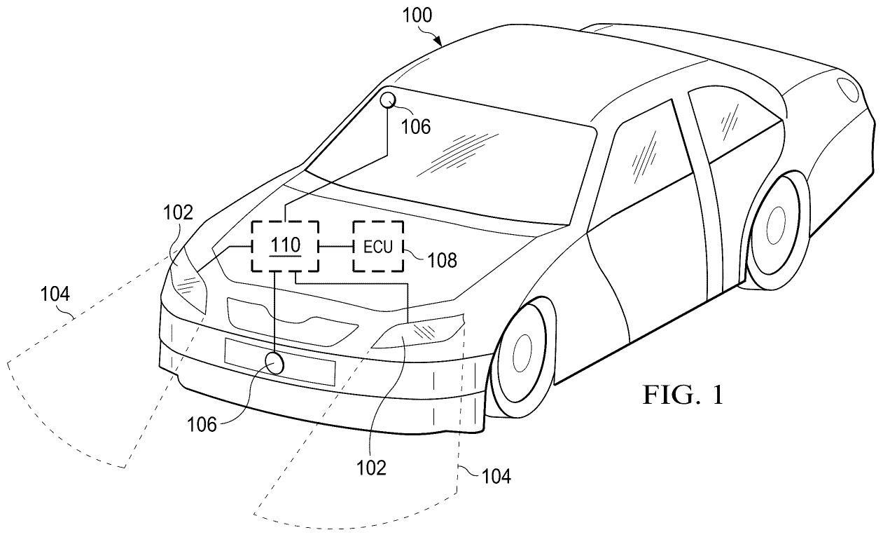

FIG. 1 is a diagram illustrating a vehicle 100 (e.g., a car) including a light projection system 110, according to certain examples described herein. The vehicle 100 includes a pair of headlights 102 that produce respective headlight beams 104 under the control/operation of the light projection system 110. It will be appreciated that some or all components of the light projection system 110 may be integrated with the headlights 102. In some examples, the vehicle 100 may include a light projection system 110 for each headlight 102. In other examples, at least some components of the light projection system 110 can be shared among both headlights 102. The vehicle 100 may further include one or more sensors 106 that may be disposed at various locations around the vehicle 100. In some examples, at least some of the sensors 106 are coupled to the light projection system 110, and information obtained from the sensors 106 can be used to dynamically adapt one or more characteristics of the headlight beams 104. These one or more characteristics of the headlight beams 104 may include one or more of: the profile of the headlight beam, a brightness of the headlight beam, or a pointing direction of the headlight beam. For example, information acquired via the sensors 106 can be used to perform adaptive driving functions, such as dimming at least a portion of the headlight beams 104 that may be directed towards (and therefore “seen” by) an oncoming vehicle. In some examples, the vehicle further includes an electronic control unit (ECU) 108 coupled to the light projection system 110. In some examples, one or more of the sensors 106 may be coupled to the ECU 108, rather than directly to the light projection system 110, and the ECU may provide sensor data to the light projection system 110.

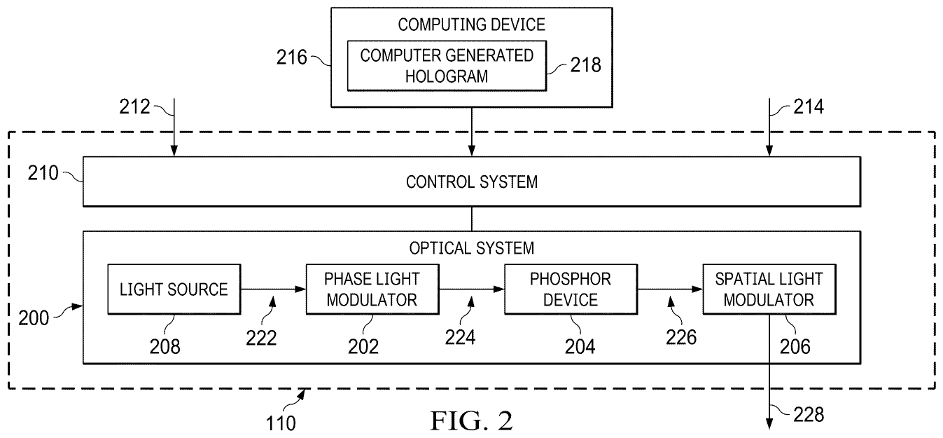

Referring to FIG. 2, there is illustrated a block diagram of the light projection system 110, according to an example. In the illustrated example, the light projection system 110 includes an optical system 200 and a control system 210. The control system 210 may be coupled to at least some components of the optical system 200, as described further below. In some examples, the optical system 200 includes a phase light modulator (PLM) 202, a phosphor device 204, a spatial light modulator (SLM) 206, and a light source 208. As discussed above, the combination of the phase light modulator 202 and the spatial light modulator 206 provides the ability to reallocate output light across the full field of view into an arbitrary profile so as to provide spatial variance of light intensity with relatively high-resolution control. The control system 210 may receive input image data 212 describing at least some characteristics of the headlight beam 104 to be produced. Further, as described above, the control system 210 may further receive sensor data 214 from the one or more sensors 106. The control system 210 may use this sensor data 214 to adjust one or more characteristics of the projected headlight beam 104, such as brightness, profile, and/or pointing direction. Thus, based at least in part on the sensor data 214, the control system 210 can control the optical system 200 to provide adaptive driving functionality, as described above.

According to certain examples, under control of the control system 210, the light source 208 produces a source beam 222. In some examples, the light source 208 is a laser-based light source that includes one or more lasers (e.g., laser diodes) that emit the source beam 222. For simplicity, the following description may refer to a laser light source. However, it will be appreciated that in other examples, another type of coherent, or partially coherent, light source can be used. For example, the light source 208 may include one or more light emitting diodes (LEDs) with narrow emission spectra, such as super-luminescent LEDs, for example. The optical system 200 is arranged such that the source beam 222 from the light source 208 illuminates the phase light modulator 202. The phase light modulator 202 modulates the source beam 222 to produce a modulated source beam 224 that is imaged onto the phosphor device 204. In some examples, and as described further below, the phase light modulator 202 is configured to modulate the source beam 222 according to a computer generated hologram (CGH) 218. Thus, in some examples, the control system 210 may obtain the CGH 218 from a computing device 216, and control the phase light modulator 202 to modulate the source beam 222 according to the CGH 218. Based on the CGH 218, the phase light modulator 202 can modulate the source beam 222 from the light source 208 to shape the profile of the projected headlight beam 104. As described further below, this profile shaping can be arbitrary (e.g., peak brightness can be positioned anywhere within with field of view) and the CGH 218 can be modified in real time to enable adaptive driving beam functions, such as adjusting the pointing direction and/or brightness of headlight beam 104 as the vehicle 100 makes turns and/or travels up or down hills, for example. In some examples, using the phase light modulator 202 for profile-shaping of the headlight beam 104 is advantageous because arbitrary, non-uniform profiles can be created in real time, as described above, without reducing overall beam brightness. In the example of FIG. 2, the computing device 216 is shown to be separate from the control system 210; however, in other examples, the computing device 216 may be part of the control system 210, as described further below. In some examples, the computing device 216 may be part of the ECU 108 of the vehicle 100.

Still referring to FIG. 2, the modulated source beam 224 from the phase light modulator 202 stimulates the phosphor device 204 to produce the illumination beam 226 that carries the profile characteristics described by the modulated source beam 224. The phosphor device 204 may include a substrate and a phosphor disposed on at least a portion of the substrate. The phosphor acts as a wavelength conversion device that, based on illumination by a beam of one wavelength (or wavelength range) produces an emission of another wavelength (or wavelength range). In some examples, the light source 208 includes a blue laser (e.g., one or more laser diodes emitting in the blue spectral range) and the phosphor device 204 includes a yellow phosphor. Thus, based on stimulation of the phosphor by the blue laser light, the phosphor produces a yellow emission. The phosphor device 204 can be further configured to either reflect or transmit at least a portion of the incident light (e.g., the modulated source beam 224 from the phase light modulator 202) in the same direction of travel as the emission from the phosphor. Thus, the phosphor device provides an illumination beam 226 that can be directed to illuminate the spatial light modulator 206. The illumination beam 226 comprises the emission from the phosphor and at least the portion of the modulated source beam 224 that is reflected/transmitted by the phosphor device 204. In the case of a blue laser and a yellow phosphor, the combination of the (modulated) blue laser light illuminating the yellow phosphor produces white light. Thus, the illumination beam 226 can be a white light beam that is encoded with a desired projection profile imparted by the phase modulation performed on the source beam 222 by the phase light modulator 202.

In some examples, the phosphor device 204 is a static device. In other examples, the phosphor device 204 can be a phosphor wheel or other movable (e.g., rotatable) device. In the case of a phosphor wheel, for example, the phosphor device 204 may comprise a first region that includes the phosphor disposed a substrate, as described above, and a second region, free of the phosphor, that transmits or reflects at least the portion of the incident modulated source beam 224. In some examples, the second region may include a diffuser to match the angular output of the transmitted/reflected portion of the modulated source beam 224 to the phosphor emission. In the case of a static phosphor device 204, the phosphor device 204 can be configured to partially convert the incident modulated source beam 224, such that the phosphor device 204 outputs both the phosphor emission (based on the converted incident light) and at least a portion of the modulated source beam 224 to produce a desired output spectrum for the illumination beam 226. Thus, the illumination beam 226 comprises a combination of the emission from the phosphor (e.g., yellow light) and the transmitted/reflected, or otherwise relatively unmodified, portion of the modulated source beam 224 (e.g., blue light). In some examples, using a laser-phosphor combination (or other coherent light source in combination with the phosphor device 204) to produce the modulated source beam 224 can be advantageous because it provides the ability to produce a high brightness beam within the potentially limited etendue of the spatial light modulator 206. In some examples, the modulated source beam 224 can be sized (by the light source 208 in combination with the phosphor device 204) to underfill the spatial light modulator 206 to match a desired aspect ratio for the output headlight beam 104 and allow for vertical image shifting.

The illumination beam 226 from the phosphor device 204 is imaged onto the spatial light modulator 206, which projects an output beam 228 (e.g., the headlight beam 104) onto a display surface, such as a roadway, for example. Thus profile characteristics of the headlight beam 104 described by the CGH 218 and encoded in the modulated source beam 224 are transferred into the output beam 228. In some examples, the spatial light modulator 206 is a high resolution device, for example, having an array of many thousands or tens of thousands of display elements (e.g., representing pixels in a displayed image). Accordingly, the spatial light modulator 206 may offer precise adaptive driving beam functionality, such as the ability to mask out features of oncoming traffic (e.g., windshields of approaching cars) to prevent glaring the driver of the oncoming vehicle(s) or reduce reflections from objects along a roadway, such as highly reflective road signs, for example. Furthermore, the high resolution capability of the spatial light modulator 206 may allow high resolution symbol projection displays for the driver and/or other persons (such as nearby pedestrians or cyclists, for example). In some examples, the spatial light modulator 206 is a micro-electromechanical device, such as a digital micromirror device. In other examples, the spatial light modulator 206 can be a liquid crystal display device, such as a liquid crystal on silicon device, for example.

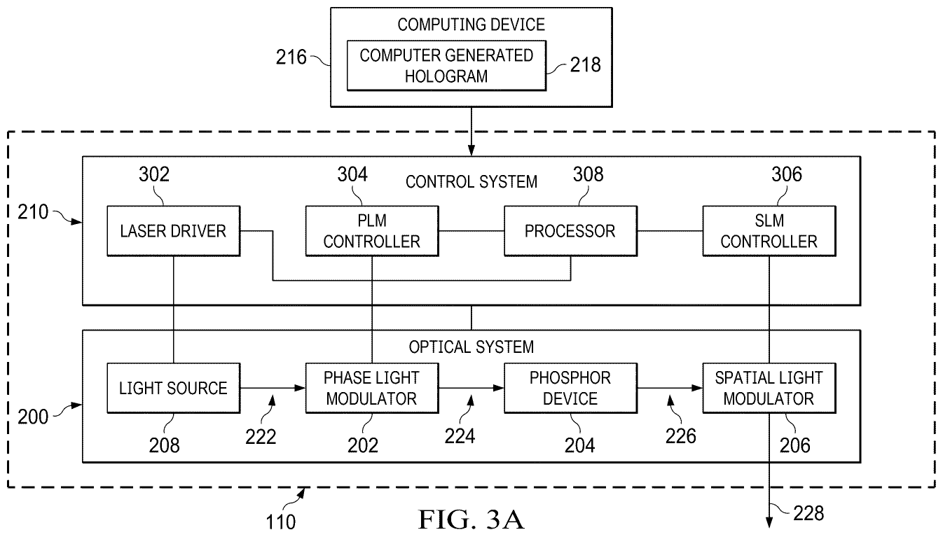

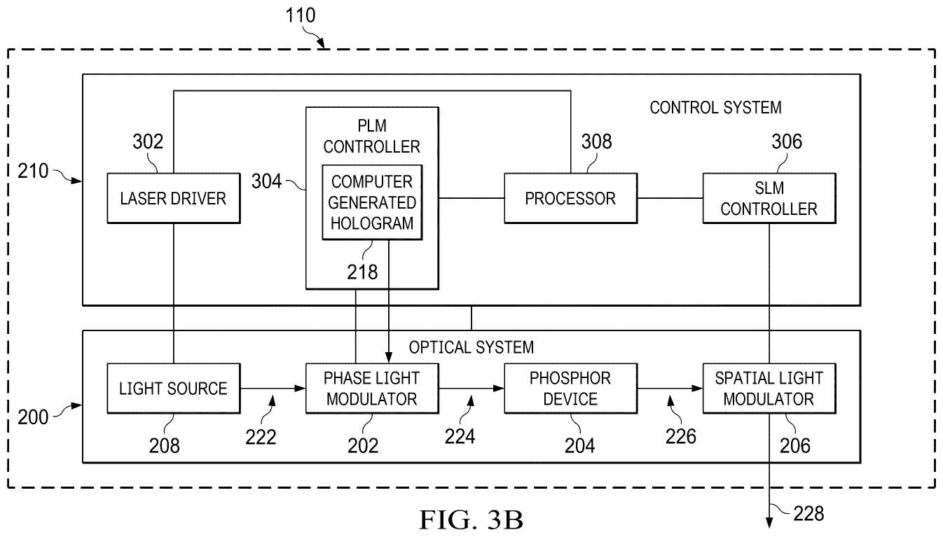

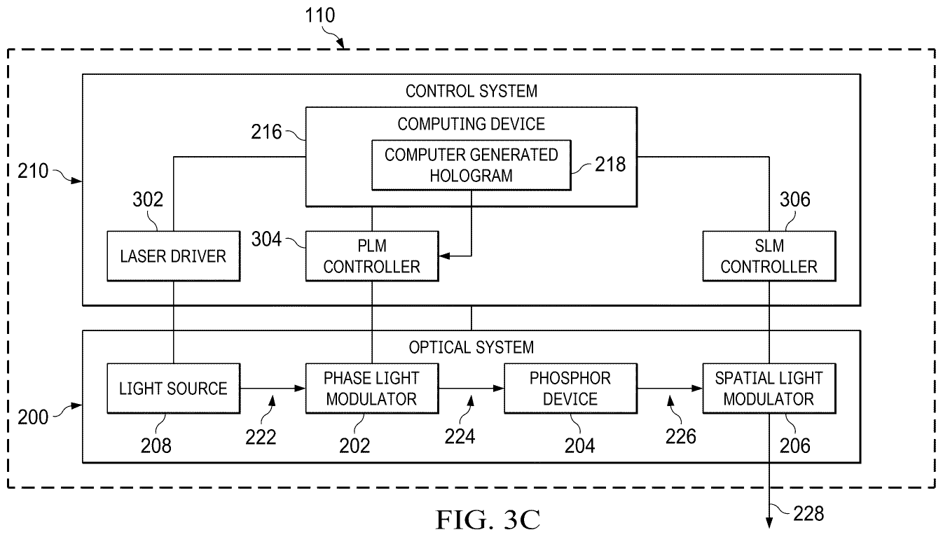

FIGS. 3A-C illustrate various configurations of the control system 210, according to certain examples. In particular, in some examples, the control system 210 includes a laser driver 302 that controls the light source 208, a PLM controller 304 that controls the phase light modulator 202, and an SLM controller 306 that controls the spatial light modulator 206.

As described above, in some examples, the light source 208 is a laser light source. Accordingly, in some such examples, the laser driver 302 may control a drive current of the laser(s) in the light source 208 to drive the laser(s) to emit the source beam 222. As described above, in some examples, the light source 208 includes a blue laser (e.g., one or more laser diodes emitting in the blue spectral range, such as wavelengths of about 400-480 nanometers) and the phosphor device 204 includes a yellow phosphor. The combination of the blue laser light illuminating the yellow phosphor device 204 can produce white light, which is projected to the spatial light modulator to produce the headlight beam 104. In some examples, controlling the brightness of the resulting white light illumination beam (and therefore of the headlight beam 104) is done by adjusting the output intensity of the laser(s). For example, the laser driver 302 can be configured to control an intensity of the source beam 222 to thereby control the brightness of the illumination beam 226 from the phosphor device 204. However, the white color point of the resulting headlight beam 104 can shift with variations in the intensity of the source beam 222. For example, the headlight beam 104 may appear more yellow when the source beam 222 has a lower intensity and more blue when the source beam 222 has a higher intensity. This color variation can be distracting and undesirable.

To alleviate the color shift, in some examples, the laser driver 302 can be configured to control the light source 208 using a pulse width modulation (PWM) scheme. Thus, rather than changing the intensity of source beam 222 emitted by the light source 208, the laser driver 302 can be configured to rapidly turn the laser(s) of the light source 208 on and off. The duty cycle, or amount of time the laser(s) spend in the on state relative to the off state, may then change the total brightness output. This brightness control can be achieved by pulsing the laser(s) on and off at a short enough time scale (e.g., faster than the critical flicker fusion rate) that the human eye averages the output intensity, rather than seeing the individual pulses of light.

In some examples, the spatial light modulator 206 may have a relatively small etendue, which may limit the volume of light that can be coupled onto it. As described above, the use of a coherent light source 208, which may be a laser light source, in combination with the phosphor device 204 may advantageously provide illumination with high output power density, thereby allowing for a high brightness output within the limited etendue of the spatial light modulator 206. Furthermore, the use of PWM control signals from the laser driver 302 may allow for variable brightness output without unwanted color changes.

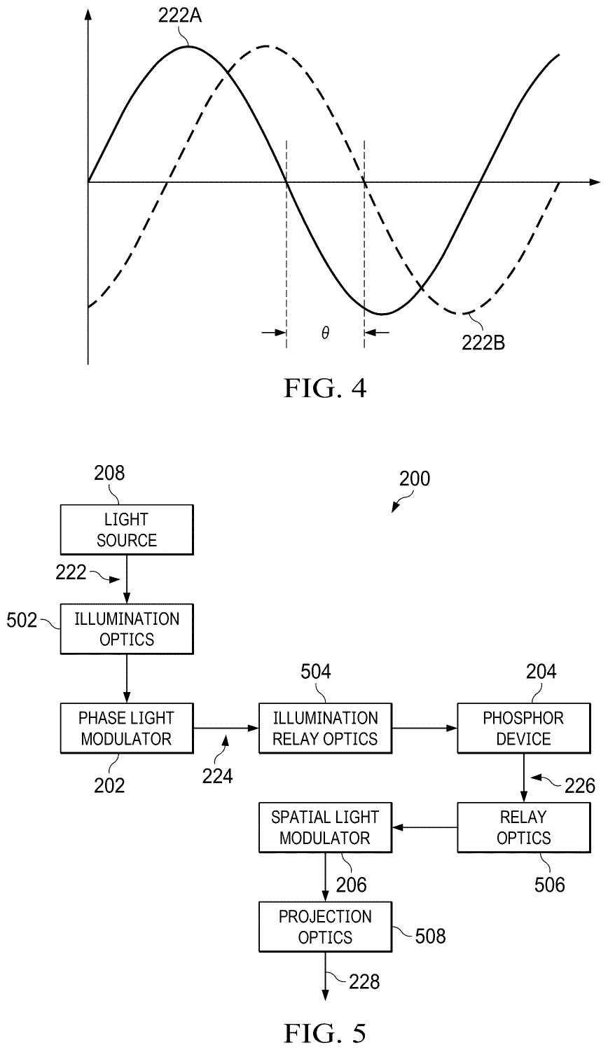

As described above, the phase light modulator 202 modulates the source beam 222 from the light source 208 to produce the modulated source beam 224 that is then directed to illuminate the phosphor device 204 to produce the illumination beam 226. In some examples, the phase light modulator 202 comprises an array of elements that individually impart phase shifts to the light rays of the incident source beam 222 so as to produce a distributed phase modulation of the source beam 222 across the array of the phase light modulator 202. For example, referring to FIG. 4, a first reflection 222A of the source beam 222 from one element of the array of elements in the phase light modulator 202 can be phase shifted (by an amount θ) relative to a second reflection 222B of the source beam 222 from another element of the array. As the reflections from different elements of the phase light modulator 202 are phase-shifted from one another, they create patterns of constructive and destructive interference, which can, respectively, increase and decrease the brightness of the modulated source beam 224 over the field of view. By controlling the individual elements of the array, different phase shifts, θ, can be applied across the array to shape the spatial brightness profile of the modulated source beam 224, and thus ultimately of the projected output beam 228 (e.g., the headlight beam 104). The phase light modulator is a diffraction-type device and all incident light (e.g., from the source beam 222) is thus directed to “on” pixels, such that the modulated source beam 224 can be shaped to create an arbitrary, non-uniform profile without throwing away light. Accordingly, a high-brightness beam can be produced, and as described above, the peak intensity (lux) point can be shifted anywhere within the field of view.

Phase modulation can be accomplished in various manners using various devices. For example, the phase light modulator 202 can include an array of mirror elements than can be spatially repositioned relative to one another in the optical path of the source beam 222 so as to modulate the optical path length and thus the phase of the reflected rays. In other examples, the phase light modulator 202 can be implemented as a liquid crystal device, such as a liquid crystal on silicon device, for example. In such examples, the phase light modulator 202 may include an array of liquid crystals that have anisotropic optical properties. Accordingly, the crystal elements can be controlled, for example, via the application of varying electric fields, to impart different phase shifts to reflected/transmitted light rays.

Referring again to FIGS. 3A-C, according to certain examples, the individual elements (or groups of elements) of the array making up the phase light modulator 202 are controlled by the PLM controller 304 to impart individual phase shifts so as to produce the desired modulated source beam 224. As described above, in some examples, the phase light modulator 202 is configured to modulate the source beam 222 according to the CGH 218. Thus, in some such examples, the PLM controller 304 can be configured to control the elements of the phase light modulator 202 to impart respective phase shifts so as to produce the spatial profile described by the CGH 218. Thus, by applying the pattern of phase shifts described by the CGH 218, the modulated source beam 224 to produce to generate a desired image at the spatial light modulator 206. In the examples of FIGS. 3A and 3C, the PLM controller 304 receives the CGH 218 from the computing device 216. However, in other examples, the PLM controller 304 may generate the CGH, as illustrated in FIG. 3B. In such examples, the PLM controller 304 may produce the CGH 218 based on input data to the control system 210, such as information contained in the image data 212 and/or the sensor data 214, for example.

Continuing with the examples of FIGS. 3A-C, the spatial light modulator 206 can be configured to project the output beam 228 (e.g., the headlight beam 104) based on the illumination beam 226 from the phosphor device 204, which contains the information from the CGH 218 encoded into the illumination beam 226 via the phase light modulator 202. As described above, the spatial light modulator 206 can be a micro-electromechanical device (e.g., a DMD), a liquid crystal display device, or another projection device that comprises an array of addressable elements. The SLM controller 306 can be configured to write image representing an image to the spatial light modulator 206 and to control the spatial light modulator 206 to display, or project, the image. In some examples, the image is represented by the image data 212 provided to the control system 210. The SLM controller 306 may control the spatial light modulator 206 to project the headlight beam 104, including image information contained in the image data 212, based on the illumination (illumination beam 226) from the phosphor device 204. For example, as described above, the spatial light modulator 206 may be a high resolution device and can thus be controlled to project symbols or other information in the output beam 228.

To project the headlight beam 104 having a desired profile and including any desired symbols at any given time, the light source 208, the phase light modulator 202, and the spatial light modulator 206 may be operated together in a synchronized manner. For example, in some instances, the SLM controller 306 can be configured to write the image data to the spatial light modulator 206, as described above, using pulse width modulation (PWM) timing signals. In such examples, the SLM controller 306 may be further configured to synchronize the PWM timing signals for the spatial light modulator 206 with enable timing signals of the laser driver 302 for the light source 208 such that the light source 208 can be controlled to appropriately illuminate the phosphor device 204 and, in turn, appropriately illuminate the spatial light modulator 206. Similarly, the PLM controller 304 can be configured to synchronize control signals for the phase light modulator 202 with the PWM timing signals for the spatial light modulator 206 and the enable timing signals of the laser driver 302. In some examples, where the laser driver 302, the PLM controller 304, and the SLM controller 306 are separate controllers, as illustrated in FIGS. 3A-C, for example, this synchronization can be achieved or directed by a processor 308 that is communicatively coupled to the laser driver 302, the PLM controller 304, and the SLM controller 306.

Referring to FIG. 3C, in some examples, rather than the computing device 216 being external to, or separate from, the control system 210, the computing device 216 may be part of the control system 210. In some such examples, the computing device 216 may be, or may include, the processor 308. Accordingly, in addition to supplying the CGH 218 to the PLM controller 304, the computing device 216 may perform some or all of the synchronization functions described above.

In other examples, some or all of the laser driver 302, the PLM controller 304, the SLM controller 306, and/or the computing device 216 may be combined into one or more computing systems that provide various aspects of the functionality of the control system 210. Numerous variations and other configurations of the control system 210, and/or computing devices communicatively coupled thereto, will be apparent, given the benefit of this disclosure, and are intended to form part of this disclosure.

Thus, using the combination of components described above, examples of the light projection system 110 can produce the projected headlight beam 104 (or other output beam 228) having dynamically variable characteristics, including overall brightness, profile, and optionally embedded symbols or other information. By dynamically updating the CGH, for example, based on the sensor data 214 and/or other information obtained by the control system 210, the profile of the headlight beam 104 can be changed in real time to adapt to movement of the vehicle 100 and/or other changing conditions. For example, the one or more characteristics of the headlight beam 104, such as the profile of the headlight beam, the brightness of the headlight beam, or the pointing direction of the headlight beam, can be adapted based on the sensor data 214 and/or other information obtained by the control system 210. As described above, by dynamically varying the phase modulation (e.g., based on the CGH 218) applied by the phase light modulator 202, the profile of the headlight beam can be changed, for example steering the peak brightness region up and down as the vehicle 100 travels through bumps or hills, and/or left and right as the vehicle makes turns. Similarly, the brightness of the projected headlight beam 104 can be dynamically and selectively dimmed in certain regions of the field of view, for example, in response to the sensor data 214 indicating oncoming traffic, or to reduce distracting reflections or glare that may be detected by the sensors 106. As the phase light modulator 202 can be configured and controlled to direct and steer the entire incident source beam 222, producing the modulated source beam 224 with an arbitrary profile based on the CGH 218, a non-uniform profile can be created over the full field of view. Thus, unlike some headlight assemblies that use a high-beam module and a separate low-beam module (one or both of which may have a static profile) to produce a desired profile over the full field of view, examples of the light projection system described herein may achieve a full field of view non-uniform profile with a single projection module, while optionally also providing additional functionality (such as high resolution adaptive driving beam control and/or symbol projection, via the spatial light modulator 206, as described above).

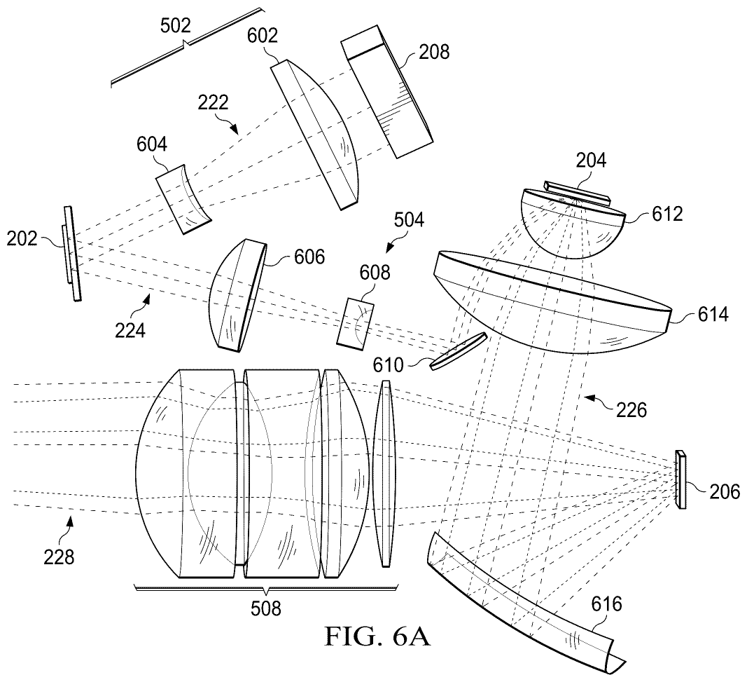

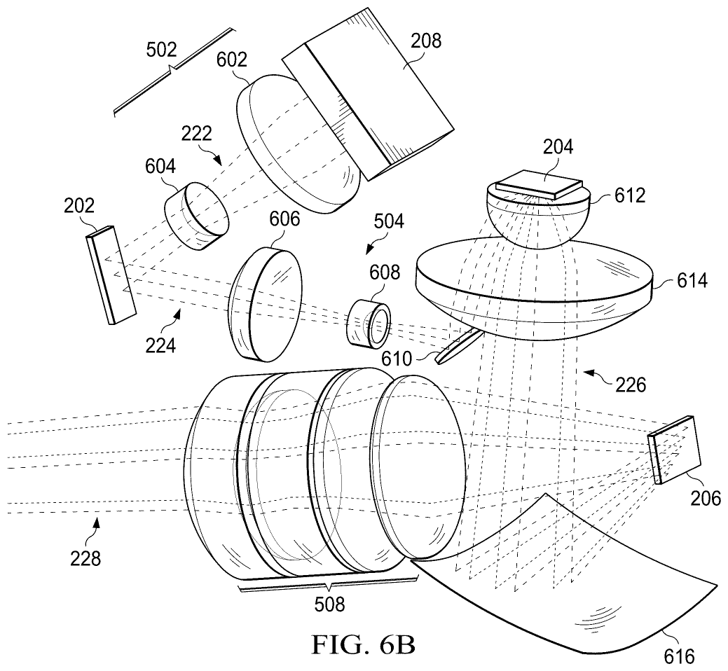

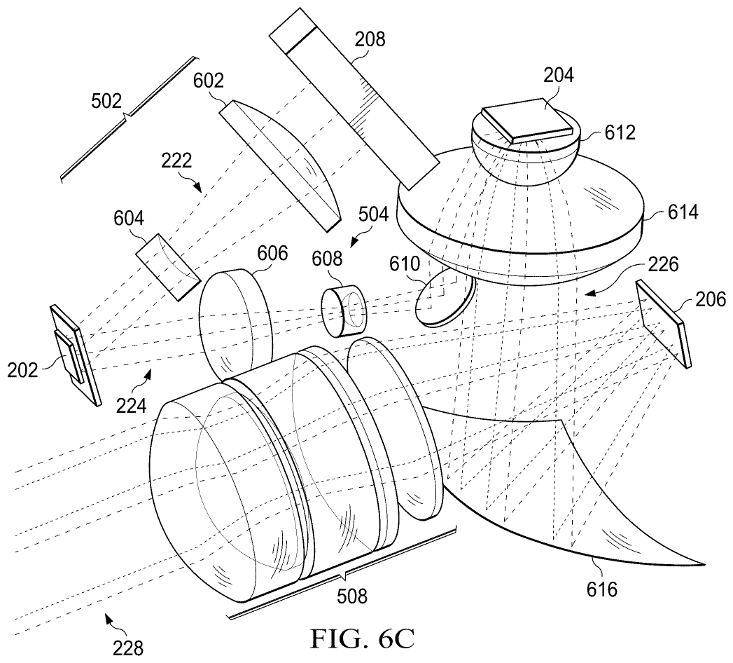

Referring to FIG. 5, the various components of the optical system 200, including the light source 208, the phase light modulator 202, the phosphor device 204, and the spatial light modulator 206, can be optically coupled together in a variety of different ways. For example, the optical system 200 may include illumination optics 502 positioned in an optical path between the light source 208 and the phase light modulator 202. The illumination optics 502 may be configured to direct the source beam 222 onto the phase light modulator 202, and optionally perform certain beam-shaping functions (e.g., collimation, focus, etc.). The optical system 200 may further include illumination relay optics 504 positioned in the optical path between the phase light modulator 202 and the phosphor device 204. The illumination relay optics 504 can be configured to direct the modulated source beam 224 from the phase light modulator 202 to the phosphor to form an image onto the phosphor device 204. As described above, the illumination beam 226 from the phosphor device 204 is imaged onto the spatial light modulator 206. Accordingly, the optical system 200 may include relay optics 506 positioned in the optical path between the phosphor device 204 and the spatial light modulator 206. The optical system 200 may further include projection optics 508 configured to image the projected beam 228 from the spatial light modulator 206 onto the display surface (e.g., the roadway). There are numerous optical configurations that may be implemented for the optical system 200. Some examples are illustrated in FIGS. 6A-9. Further, it will be appreciated that, depending on the optical configuration, certain optical elements (e.g., one or more lenses and/or mirrors) may be shared among some or all of the illumination optics 502, the illumination relay optics 504, the relay optics 506, and/or the projection optics 508.

Referring to FIGS. 6A-C, there is illustrated an optical configuration of the optical system 200, according to an example. FIG. 6A shows a side view, FIG. 6B shows a perspective view from a first viewpoint, and FIG. 6C shows another perspective view from a second viewpoint. The light source 208 emits the source beam 222. In some examples, the light source 208 includes an integrated lens group such that the emitted source beam 222 is collimated. The source beam 222 travels along an optical path from the light source 208 through the illumination optics 502 to the phase light modulator 202. Thus, the light source 208 is optically coupled to the phase light modulator 202 via the illumination optics 502. In the example of FIGS. 6A-C, the illumination optics 502 includes two beam-shaping lenses 602 and 604 that reduce the diameter of the collimated source beam 222 to appropriately size the beam incident on the phase light modulator 202. However, in other examples, more or fewer than two beam-shaping lenses can be used.

In the example of FIGS. 6A-C, the illumination relay optics 504 includes first and second illumination relay lenses 606 and 608, respectively, along with a fold mirror 610. The modulated source beam 224 thus travels along an optical path from the phase light modulator 202 through the illumination relay lenses 606 and 608 to the fold mirror 610. In addition, the optical system 200 includes first and second collimator lenses 612 and 614 that are shared between the illumination relay optics 504 and the relay optics 506 of FIG. 5. The modulated source beam 224 is reflected by the fold mirror 610 towards the collimator lens 614, and travels from the fold mirror 610 through the collimator lenses 614 and 612 to the phosphor device 204. Thus, the phosphor device 204 is optically coupled to the phase light modulator 202 via the illumination relay lenses 606 and 608, the fold mirror 610, and the collimator lenses 612, 614. In the example of FIGS. 6A-C, the relay optics 506 of FIG. 5 further include an illumination relay mirror 616. In some examples, the relay mirror 616 is curved, as illustrated in FIGS. 6A-C, so as to perform a focusing function. The illumination beam 226 travels along an optical path from the phosphor device 204 through the collimator lenses 612, 614, to the illumination relay mirror 616, which reflects the illumination beam 226 onto the spatial light modulator 206. Thus, the spatial light modulator 206 is optically coupled to the phosphor device 204 via the collimator lenses 612, 614 and the illumination relay mirror 616. In other examples, the relay mirror 616 can be replaced with a focusing lens (along with appropriate resulting modifications to the optical layout, as will be appreciated by those skilled in the art, given the benefit of this disclosure). The spatial light modulator 206 projects the output beam 228 (e.g., the headlight beam 104) to the projection optics 508.

In the example of FIGS. 6A-C, due to the positioning of the phase light modulator 202 relative to the phosphor device 204, the fold mirror 610 is used to redirect the modulated source beam 224 to the second collimator lens 614. The modulated source beam 224 is imaged by the second collimator lens 614 and the first collimator lens 612 onto the phosphor device 204. In this example, the phosphor device 204 is a reflective phosphor. Accordingly, the illumination beam 226 (comprising the phosphor emission and a reflected portion of the modulated source beam 224, as discussed above) from the phosphor device 204 is imaged via the first and second collimator lenses 612, 614 and the illumination relay mirror 616 onto the spatial light modulator 206. The illumination relay mirror 616 redirects the illumination beam 226 to account for the relative positioning of the phosphor device 204 and the spatial light modulator 206 in the optical configuration of FIGS. 6A-C.

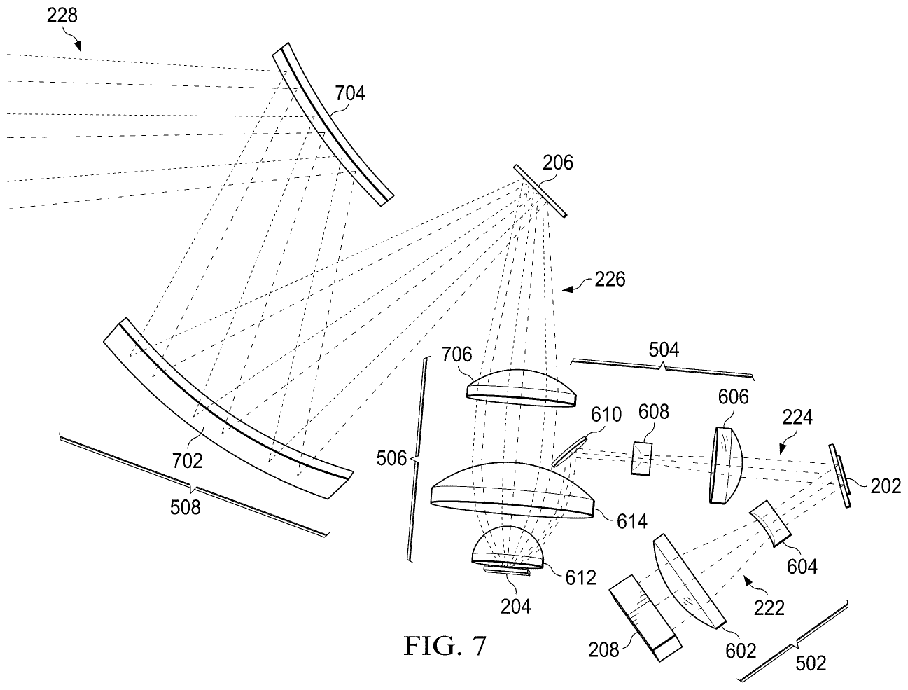

In the example of FIGS. 6A-C, the projection optics 508 comprises a series or group of five lenses, as shown. However, in other examples, more or fewer than five lenses can be used in the projection optics 508. Furthermore, in other examples, the projection optics 508 can be implemented using reflective optics rather than refractive optics. For example, referring to FIG. 7, there is illustrating an optical configuration of the optical system 200 in which the projection optics 508 are implemented using reflective optical elements. In the illustrated example of FIG. 7, the projection optics 508 of FIG. 5 include a first mirror 702 and a second mirror 704. However, in other examples, more or fewer mirrors can be used. Further, in other examples, a combination of reflective and refractive optics can be used for the projection optics 508 and/or for any of the illumination optics 502, the illumination relay optics 504, and/or the relay optics 506. In addition, in the example of FIG. 7, due at least in part to the spatial positioning of the phosphor device 204 relative to the spatial light modulator 206, the illumination relay mirror 616 of the configuration shown in FIGS. 6A-C is replaced with an illumination relay lens 706. The illumination relay lens 706, in combination with the collimator lenses 612, 614 image the illumination beam 226 from the phosphor device 204 onto the spatial light modulator 206, as described above.

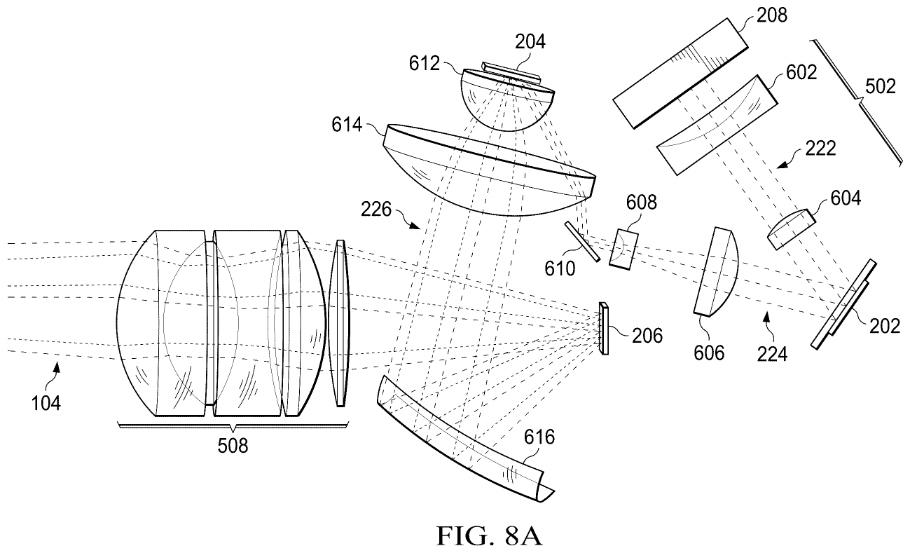

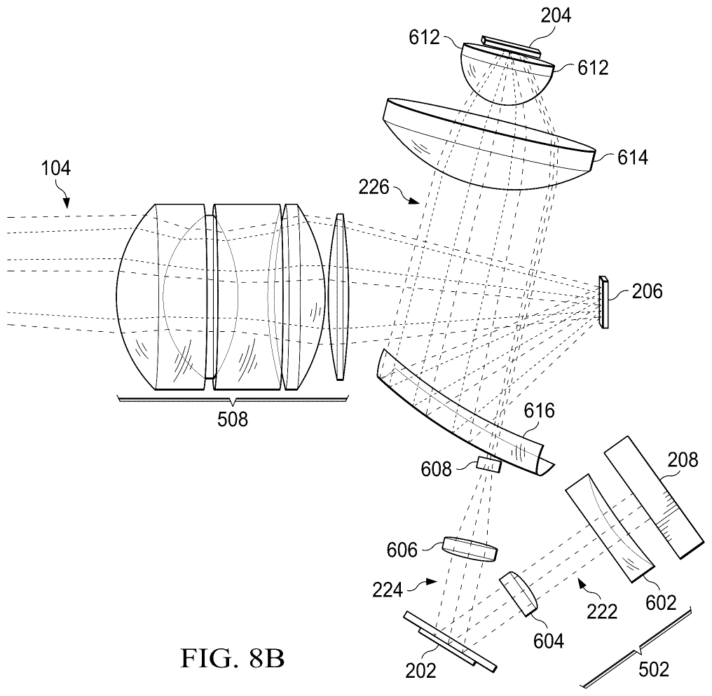

Numerous other spatial positioning and arrangements of the various elements of the optical system 200 can be implemented. For example, FIG. 8A illustrates an optical configuration in which the light source 208 and the phase light modulator 202 are positioned to one side of the phosphor device 204 in a spatial arrangement that differs from the positioning illustrated in FIG. 6A-C. In the example of FIG. 8A, the source beam 222 travels along an optical path from the light source 208 through the beam-shaping lenses 602 and 604 to the phase light modulator 202. Thus, the phase light modulator 202 is optically coupled to the light source 208 via the beam-shaping lenses 602 and 604. The modulated source beam 224 travels along an optical path from the phase light modulator 202 through the illumination relay lenses 606 and 608 to the fold mirror 610, and is reflected from the fold mirror 210 to the second collimator lens 614. The modulated source beam 224 travels along an optical path from the fold mirror 610 through the collimator lenses 614, 612 to the phosphor device 204. Thus, the phase light modulator 202 is optically coupled to the phosphor device 204 via the illumination relay lenses 606 and 608, the fold mirror 610, and the collimator lenses 614, 612. The illumination beam 226 travels along an optical path from the phosphor device 204, through the collimator lenses 612, 614 to the illumination relay mirror 616, and is reflected from the illumination relay mirror 616 onto the spatial light modulator 206. Thus, the spatial light modulator 206 is optically coupled to the phosphor device 204 via collimator lenses 612, 614 and the illumination relay mirror 616. The headlight beam 104 (as an example of the output beam 228 of FIG. 5) is projected from the spatial light modulator 206 through the projection optics 508.

Similarly, FIG. 8B illustrates another optical configuration in which the light source 208 and the phase light modulator 202 are positioned below the phosphor device 204. Similar to the example of FIG. 8A, the source beam 222 travels along an optical path from the light source 208 through the beam-shaping lenses 602 and 604 to the phase light modulator 202. Thus, the phase light modulator 202 is optically coupled to the light source 208 via the beam-shaping lenses 602 and 604. The phase light modulator 202 is further optically coupled to the phosphor device 204. In the arrangement of FIG. 8B, the modulated source beam 224 from the phase light modulator 202 travels through the illumination relay lenses 606 and 608, past the illumination relay mirror 616, and through the collimator lenses 614, 612 to the phosphor device 204. For example, the illumination relay mirror 616 may include an aperture positioned to allow the modulated source beam 224 to pass through. In another example, the illumination relay mirror 616 may include a dichroic coated region that transmits the modulated source beam 224 (e.g., blue light) and reflects the illumination beam 226 from the phosphor (e.g., yellow light). For example, the modulated source beam 224 can be positioned at the center of the relay mirror 616 and center of the illumination beam 226. Since this is in collimated space, this arrangement may not result in any significant color non-uniformity on the spatial light modulator 206 since blue light in the optical path after the phosphor device 204 would not arrive at the spatial light modulator 206 within that small region. Light can be transmitted through area, such that a combination of blue and yellow light can be present within that small region of the pupil. Further, the fold mirror 610 in the illumination relay optics 506 is omitted. Similar to the example shown in FIG. 8A, the illumination beam 226 travels from the phosphor device 204 through the collimator lenses 612, 614 to the illumination relay mirror 616, and is reflected from the illumination relay mirror 616 to the spatial light modulator 206. The spatial light modulator 206 is thus optically coupled to the phosphor device via the collimator lenses 612, 614 and the illumination relay mirror 616. The light is projected from the spatial light modulator 206 through the projection optics 508 to provide the headlight beam 104 (e.g., as an example of the output beam 228 of FIG. 5).

It will be appreciated that numerous other configurations are possible. Further, in any of the examples shown in FIGS. 6A-C, 8A, and/or 8B (and/or for other arrangements of the light source 208, phase light modulator 202, phosphor device 204 and/or spatial light modulator 206) the refractive projection optics 508 can be replaced with reflective projection optics, as illustrated in FIG. 7, for example.

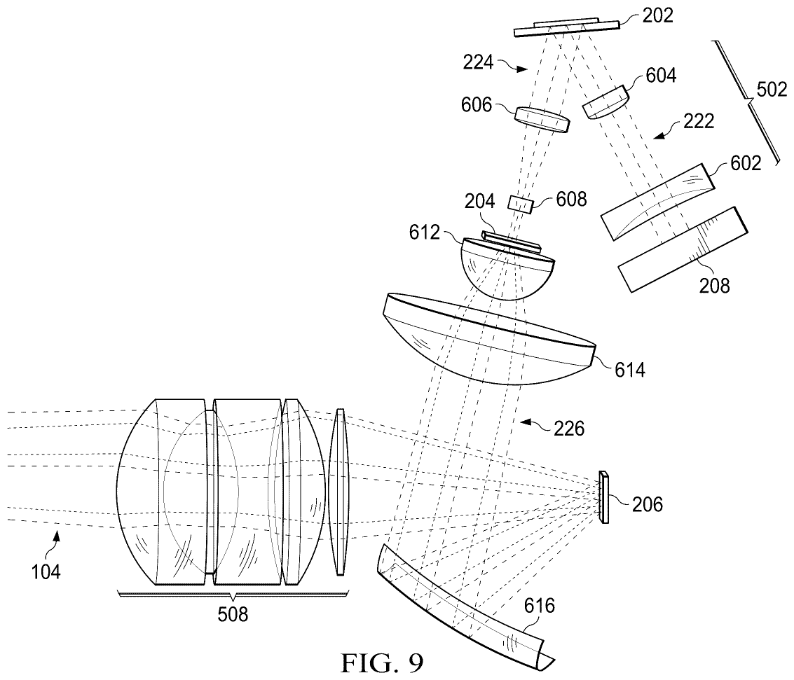

In the examples illustrated in FIGS. 6A-8B, the phosphor device 204 is a reflective phosphor device. However, as described above, in some examples, a transmissive phosphor device 204 can be used. Accordingly, FIG. 9 illustrates an example of an optical configuration of the optical system 200 of FIG. 5 in which the phosphor device 204 is a transmissive phosphor device. In this example, the source beam 222 travels along an optical path from the light source 208 through the beam-shaping lenses 602 and 604 to the phase light modulator 202. Thus, the phase light modulator 202 is optically coupled to the light source 208 via the beam-shaping lenses 602 and 604. The phase light modulator 202 is further optically coupled to the phosphor device 204. In the example of FIG. 9, the modulated source beam 224 travels from the phase light modulator 202 through the illumination relay lenses 606 and 608 to the phosphor device 204. However, rather than reflect at least the portion of the incident modulated source beam 224 from the phase light modulator 202, the phosphor device 204 transmits the portion towards the spatial light modulator 206, along with the emission from the phosphor, as described above. Thus, the illumination beam 226 travels from the phosphor device 204 through the collimator lenses 612, 614 and is reflected by the illumination relay mirror 616 to the spatial light modulator 206. The phosphor device 204 is optically coupled to the spatial light modulator 206 via the collimator lenses 612, 614 and the illumination relay mirror 616. In this configuration, the fold mirror 610 in the illumination relay optics 504 is also omitted. The light is projected from the spatial light modulator 206 through the projection optics 508 to produce the headlight beam 104. It will be appreciated that numerous other optical arrangements using a transmissive phosphor device 204 can be implemented.

### Further Examples

The following examples pertain to further arrangements and/or implementations, from which numerous permutations and configurations will be apparent.

Example 1 is a light projector comprising a phase light modulator, a phosphor device optically coupled to the phase light modulator, and a spatial light modulator optically coupled the phosphor device, wherein the phosphor device is positioned in an optical path between the phase light modulator and the spatial light modulator.

Example 2 includes the light projector of Example 1, wherein at least one of the spatial light modulator or the phase light modulator comprises an electromechanical device comprising an array of mirror elements.

Example 3 includes the light projector of Example 1, wherein the spatial light modulator is a liquid crystal display device.

Example 4 includes the light projector of one of Examples 3 or 4, wherein the phase light modulator comprises a liquid crystal on silicon device.

Example 5 includes the light projector of any one of Examples 1-4, further comprising a light source optically coupled to the phase light modulator, wherein the phase light modulator is positioned in the optical path between the light source and the phosphor device.

Example 6 includes the light projector of Example 5, wherein the light source comprises a coherent light source, such as a laser, a super-luminescent light emitting diode (LED), or other LED having a narrow emission spectrum.

Example 7 includes the light projector of Example 6, wherein the coherent light source comprises a blue laser, and wherein the phosphor device comprises a yellow phosphor.

Example 8 includes the light projector of one of Examples 6 or 7, wherein the light source comprises a controller coupled to the laser and configured to operate the laser based on a pulse width modulation control signal to control an intensity of a source beam emitted by the light source.

Example 9 includes the light projector of any one of Examples 5-8, wherein the phase light modulator is configured to configured to modulate, according to a computer generated hologram, a source beam emitted by the light source.

Example 10 includes the light projector of any one of Examples 1-9, further comprising first relay optics positioned in the optical path between the phase light modulator and the phosphor device, and second relay optics positioned in the optical path between the phosphor device and the spatial light modulator.

Example 11 includes the light projector of Example 10, wherein the phosphor device is a reflective phosphor device.

Example 12 includes the light projector of Example 11, further comprising projection optics optically coupled to the spatial light modulator, wherein, in operation, the spatial light modulator is configured to produce a light beam having a profile based on an illumination beam from the phosphor device, and wherein the projection optics are configured to project the light beam from the spatial light modulator.

Example 13 includes the light projector of Example 10, wherein the phosphor device is a transmissive phosphor device.

Example 14 is a headlight assembly comprising the light projector of any one of Examples 1-13.

Example 15 is a headlight assembly comprising a light projector. The light projector includes a phosphor device comprising a phosphor; a phase light modulator arranged to illuminate the phosphor device with a modulated source beam to stimulate the phosphor to produce an emission; and a spatial light modulator arranged to receive the an illumination beam from the phosphor device and configured to project a headlight beam based on the illumination beam, wherein the illumination beam comprises the emission from the phosphor and at least a portion of the modulated source beam.

Example 16 includes the headlight assembly of Example 15, wherein the phase light modulator is configured to modulate an incident laser source beam to produce the modulated source beam, wherein the light projector further includes first relay optics configured to direct the modulated source beam to the phosphor device, and wherein the phosphor device is configured to produce the emission based on the modulated source beam.

Example 17 includes the headlight assembly of Example 16, wherein the light projector further includes a laser light source configured to emit the laser source beam.

Example 18 includes the headlight assembly of one of Examples 16 or 17, further comprising a control system coupled to the light projector and configured to control the light projector to shape a profile of the headlight beam.

Example 19 includes the headlight assembly of Example 18, wherein the control system includes a modulation controller coupled to the phase light modulator and configured to control the phase light modulator to modulate the laser source beam according to a computer generated hologram to shape the profile of the headlight beam.

Example 20 includes the headlight assembly of any one of Examples 15-19, wherein at least one of the spatial light modulator or the phase light modulator is one of an electromechanical device comprising an array of mirror elements, or a liquid crystal display device.

Example 21 is a vehicle comprising one or more headlight assemblies according to any one of Examples 15-20.

Example 22 is a vehicle comprising a headlight assembly that includes a light projector. The light projector comprises a light source configured to emit a source beam, a phase light modulator configured to modulate the source beam according to a computer generated hologram to produce a modulated source beam, a phosphor device configured to provide an illumination beam based on the modulated source beam, and a spatial light modulator configured to project a headlight beam having a profile responsive to the illumination beam from the phosphor device. The headlight assembly further includes a control system coupled to the light projector and configured to control the light projector to shape a profile of the headlight beam. The vehicle further comprises and at least one sensor coupled to the control system, wherein the control system is configured to control the light projector, based on a signal from the at least one sensor, to adjust one or more characteristics of the headlight beam.

Example 23 includes the vehicle of Example 22, wherein the one or more characteristics of the headlight beam include one or more of: the profile of the headlight beam, a brightness of the headlight beam, or a pointing direction of the headlight beam.

Example 24 includes the vehicle of one of Examples 22 or 23, wherein the light source is a blue laser, wherein the phosphor device comprises a yellow phosphor configured to produce an emission based on stimulation by the modulated source beam, and wherein the illumination beam comprises the emission and at least a portion of the modulated source beam.

Example 25 includes the vehicle of one of Examples 22 or 23, wherein the light source comprises a laser and a controller, wherein the controller is coupled to the laser and configured to operate the laser according to a pulse width modulation signal to control an intensity of the source beam.

Example 26 includes the vehicle of one of Examples 22 or 23, wherein the light source is a coherent light source.

Example 27 is a light projector comprising: a phase light modulator configured to modulate an incident source beam to produce a modulated source beam; a phosphor device arranged to receive the modulated source beam and configured to produce an emission based on the modulated source beam; and a spatial light modulator arranged to receive an illumination beam from the phosphor device and is configured to project a light beam having a profile based on the illumination beam, wherein the illumination beam comprises the emission from the phosphor device in combination with at least a portion of the modulated source beam.

Example 28 includes the light projector of Example 27, wherein the spatial light modulator comprises a digital micromirror device.

Example 29 includes the light projector of Example 27, wherein the spatial light modulator is a liquid crystal display device.

Example 30 includes the light projector of any one of Examples 27-29, further comprising a light source configured to emit the source beam.

Example 31 includes the light projector of Example 30, wherein the light source is a coherent light source.

Example 32 includes the light projector of Example 31, wherein the light source comprises a blue laser.

Example 33 includes the light projector of Example 32, wherein the phosphor device comprises a yellow phosphor.

Example 34 includes the light projector of one of Examples 32 or 33, wherein the light source comprises a controller coupled to the blue laser and configured to operate the blue laser based on a pulse width modulation control signal to control an intensity of the source beam emitted by the light source.

Example 35 includes the light projector of any one of Examples 27-34, further comprising illumination relay optics positioned in a first optical path between the phase light modulator and the phosphor device and configured to form an image at the phosphor device based on the modulated source beam.

Example 36 includes the light projector of Example 35, further comprising relay optics positioned in a second optical path between the phosphor device and the spatial light modulator and configured to image the illumination beam from the phosphor device onto the spatial light modulator.

Example 37 includes the light projector of Example 36, wherein the phosphor device is a reflective phosphor device configured to reflect the portion of the modulated source beam to the relay optics.

Example 38 includes the light projector of any one of Examples 35-37, further comprising projection optics configured to project the light beam from the spatial light modulator onto a surface.

Example 39 includes the light projector of any one of Examples 27-38, wherein the phase light modulator is configured to modulate the incident source beam based according to a computer generated hologram.

Example 40 is a headlight assembly including the light projector of any one of Examples 27-39.

Example 41 is a light projection system comprising: a light source configured to emit a source beam; a phase light modulator configured to modulate the source beam according to a computer generated hologram to produce a modulated source beam; a phosphor device including a phosphor configured to produce an emission based on the modulated source beam; and a spatial light modulator configured to project a light beam having a profile based on an illumination beam received from the phosphor device, wherein the illumination beam comprises the emission and at least a portion of the modulated source beam.

Example 42 includes the light projection system of Example 41, wherein the light source is a blue laser; and wherein the phosphor device comprises a yellow phosphor.

Example 43 includes the light projection system of Example 41, wherein the light source comprises a laser, and a controller coupled to the laser and configured to operate the laser according to a pulse width modulation signal to control an intensity of the source beam.

Example 44 includes the light projection system of Example 41, wherein the light source comprises a coherent light source, such as a laser, super-luminescent LED, or other LED having a narrow emission spectrum.

Example 45 is a system comprising a phase light modulator, a phosphor device optically coupled to the phase light modulator, and a spatial light modulator optically coupled the phosphor device.

Example 46 includes the system of Example 45, wherein at least one of the spatial light modulator or the phase light modulator comprises an electromechanical device comprising an array of mirror elements.

Example 47 includes the system of one of Examples 45 or 46, wherein the spatial light modulator is a liquid crystal display device.

Example 48 includes the system of any one of Examples 45-47, wherein the phase light modulator comprises a liquid crystal on silicon device.

Example 49 includes the system of any one of Examples 45-48, further comprising a light source optically coupled to the phase light modulator.

Example 50 includes the system of Example 49, wherein the light source comprises a blue laser, and wherein the phosphor device comprises a yellow phosphor.

Example 51 includes the system of one of Examples 49 or 50, further comprising a controller coupled to the light source and configured to operate the light source based on a pulse width modulation control signal to control an intensity of a source beam emitted by the light source.

Example 52 includes the system of any one of Examples 45-51, further comprising first relay optics optically coupled between the phase light modulator and the phosphor device, and second relay optics optically coupled between the phosphor device and the spatial light modulator.

Example 53 includes the system of Example 52, wherein the phosphor device is a reflective phosphor device.

Example 54 includes the system of Example 53, further comprising projection optics optically coupled to the spatial light modulator, wherein the spatial light modulator is configured to produce a light beam having a profile responsive an illumination from the phosphor device, and wherein the projection optics are configured to project the light beam from the spatial light modulator.

Example 55 is a headlight assembly comprising: a phosphor; a phase light modulator arranged to illuminate the phosphor with a modulated beam to stimulate the phosphor to produce an illumination beam comprising an emission from the phosphor and at least a portion of the modulated beam, and a spatial light modulator arranged to receive the illumination beam from the phosphor and configured to produce a headlight beam based on the illumination beam.

Example 56 includes the headlight assembly of Example 55, wherein the phase light modulator is configured to modulate an incident source beam to produce the modulated beam, wherein the headlight assembly further includes first relay optics configured to direct the modulated beam towards the phosphor, and wherein the phosphor is configured to produce the emission responsive to the modulated beam.

Example 57 includes the headlight assembly of Example 56, wherein the headlight assembly further includes a light source configured to emit the modulated beam.

Example 58 includes the headlight assembly of one of Examples 56 or 57, further comprising a control system coupled to the spatial light modulator and to the phase light modulator and configured to control the headlight assembly to shape a profile of the headlight beam.

Example 59 includes the headlight assembly of Example 58, wherein the control system includes a modulation controller coupled to the phase light modulator and configured to control the phase light modulator to produce the modulated beam according to a computer generated hologram to shape the profile of the headlight beam.

Example 59 includes the headlight assembly of any one of Examples 55-58, wherein at least one of the spatial light modulator or the phase light modulator is one of an electromechanical device comprising an array of mirror elements, or a liquid crystal display device.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Elements that are “optically coupled” have an optical path between them. For example, element A and element B are optically coupled if light may travel from element A to element B and/or light may travel from element B to element A. Being optically coupled does not require light to be actively propagating between the elements. Optically coupled elements are in an arrangement where light, if present, is capable of propagating from element A to element B or from element B to element A. Additionally, elements that are optically coupled may have additional elements, for example lenses, mirrors, prisms, light tunnels, or other optical elements, in the light path between them.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

In this description, unless otherwise stated, “about,” “approximately” or “substantially” preceding a parameter means being within a range of that parameter, such as +/−10 percent of that parameter or +/−5 percent of that parameter.

Modifications are possible in the described examples, and other examples are possible within the scope of the claims.

What is claimed is:

1. A system comprising:
a phase light modulator;
a phosphor device optically coupled to the phase light modulator; and
a spatial light modulator optically coupled the phosphor device.

2. The system of claim 1, wherein at least one of the spatial light modulator or the phase light modulator comprises an electromechanical device comprising an array of mirror elements.

3. The system of claim 1, wherein the spatial light modulator is a liquid crystal display device.

4. The system of claim 1, wherein the phase light modulator comprises a liquid crystal on silicon device.

5. The system of claim 1, further comprising:
a light source optically coupled to the phase light modulator.

6. The system of claim 5, wherein the light source comprises a blue laser; and
wherein the phosphor device comprises a yellow phosphor.

7. The system of claim 5, further comprising a controller coupled to the light source and configured to operate the light source based on a pulse width modulation control signal to control an intensity of a source beam emitted by the light source.

8. The system of claim 1, further comprising:
first relay optics optically coupled between the phase light modulator and the phosphor device; and
second relay optics optically coupled between the phosphor device and the spatial light modulator.

9. The system of claim 8, wherein the phosphor device is a reflective phosphor device.

10. The system of claim 9, further comprising:
projection optics optically coupled to the spatial light modulator;
wherein the spatial light modulator is configured to produce a light beam having a profile responsive an illumination from the phosphor device; and
wherein the projection optics are configured to project the light beam from the spatial light modulator.

11. A headlight assembly comprising:
a phosphor,
a phase light modulator arranged to illuminate the phosphor with a modulated beam to stimulate the phosphor to produce an illumination beam comprising an emission from the phosphor and at least a portion of the modulated beam, and
a spatial light modulator arranged to receive the illumination beam from the phosphor and configured to produce a headlight beam based on the illumination beam.

12. The headlight assembly of claim 11, wherein:
the phase light modulator is configured to modulate an incident source beam to produce the modulated beam;
the headlight assembly further includes first relay optics configured to direct the modulated beam towards the phosphor; and
the phosphor is configured to produce the emission responsive to the modulated beam.

13. The headlight assembly of claim 12, wherein the headlight assembly further includes a light source configured to emit the modulated beam.

14. The headlight assembly of claim 12, further comprising:
a control system coupled to the spatial light modulator and to the phase light modulator and configured to control the headlight assembly to shape a profile of the headlight beam.

15. The headlight assembly of claim 14, wherein the control system includes a modulation controller coupled to the phase light modulator and configured to control the phase light modulator to produce the modulated beam according to a computer generated hologram to shape the profile of the headlight beam.

16. The headlight assembly of claim 11, wherein at least one of the spatial light modulator or the phase light modulator is one of:
an electromechanical device comprising an array of mirror elements; or a liquid crystal display device.

17. A vehicle comprising:
a headlight assembly including
a light projector comprising
a light source configured to emit a source beam,
a phase light modulator configured to modulate the source beam according to a computer generated hologram to produce a modulated source beam,
a phosphor device configured to provide an illumination beam based on the modulated source beam, and
a spatial light modulator configured to project a headlight beam having a profile responsive to the illumination beam from the phosphor device, and a control system coupled to the light projector and configured to control the light projector to shape a profile of the headlight beam; and
at least one sensor coupled to the control system, wherein the control system is configured to control the light projector, based on a signal from the at least one sensor, to adjust one or more characteristics of the headlight beam.

18. The vehicle of claim 17, wherein the one or more characteristics of the headlight beam include one or more of: the profile of the headlight beam, a brightness of the headlight beam, or a pointing direction of the headlight beam.

19. The vehicle of claim 17, wherein:
the light source is a blue laser;
the phosphor device comprises a yellow phosphor configured to produce an emission based on stimulation by the modulated source beam; and
the illumination beam comprises the emission and at least a portion of the modulated source beam.

20. The vehicle of claim 17, wherein the light source comprises:
a laser; and
a controller coupled to the laser and configured to operate the laser according to a pulse width modulation signal to control an intensity of the source beam.
